(19) United States
(12) Patent Application Publication
(10) Pub. No.: US 2006/0218553 A1
(43) Pub. Date: Sep. 28, 2006

(54) Potentially hazardous material request and approve methods and apparatuses

(75) Inventors: Tim Dore, Lake Oswego, OR (US); David Karstens, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Dolphin Software, Inc.

(21) Appl. No.: 11/090,382

(22) Filed: Mar. 25, 2005

(51) Int. Cl. G06F 9/46

(52) U.S. Cl. 718/102

(57) ABSTRACT

An apparatus is provided with instructions adapted to facilitate a user in submitting online a request for a potentially hazardous material, tracking of the request, and/or approval of the request. Tracking of the request may include statuses of a plurality of tasks, which completions are required prior to the approval of the request.

### FIELD OF THE INVENTION

The present invention relates generally to the fields of data processing and potentially hazardous material management.

### BACKGROUND OF THE INVENTION

Numerous modern industries employ potentially hazardous materials in their day-to-day operation, including but are not limited to the development, manufacturing and distribution of their products. Such industries include but are not limited to the semiconductor, electronic, automotive, and refining industries.

The term potentially hazardous material (PHM) as used herein refers to the broad range of materials that may raise health, safety and/or environmental issues, including in particular those, which usage requires the maintenance of their material safety data sheets (MSDS) by the usage entity. Examples of these materials include but are not limited to the materials regulated by e.g. the Environmental Protection Agency of U.S. Government.

A MSDS of a PHM typically specifies the constitutions, special handling, storage, fire fighting procedures of the PHM. Not only the special handling and storage procedures have to be followed, the MSDS data must be updated and kept current. Resultantly, PHM usage not only has to be managed, further, proper management is a cost/profit issue as well as a health, safety and environment issue. Thus, it is desirable for entities to manage PHM usage efficiently and/or effectively, in particular, the usage request and approval process.

The term “entity” as used herein refers to any organization units, business or non-business, for profit or non-profit.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a data organization suitable for use to implement the PHM DB of the server of FIG. 1, in accordance with various embodiments;

FIG. 3 illustrates one aspect of an user interface provided by the PHM Management Software of FIG. 1, in accordance with various embodiments;

FIG. 4a-4c illustrate additional aspects of the user interface provided by the PHM Management Software of FIG. 1, in accordance with various embodiments;

FIG. 5 illustrates a flow chart view of selected operations of the PHM Management Software of FIG. 1, in accordance with various embodiments; and

FIG. 6 illustrates the server of FIG. 1 in further detail, in accordance with various embodiments.

### DETAILED DESCRIPTION OF ILLUSTRATIVE EMBODIMENTS

Illustrative embodiments of the present invention include but are not limited to methods for facilitating an entity to manage PHM usage, and hardware/software endowed to practice and/or support the practice of the methods in whole or in part.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

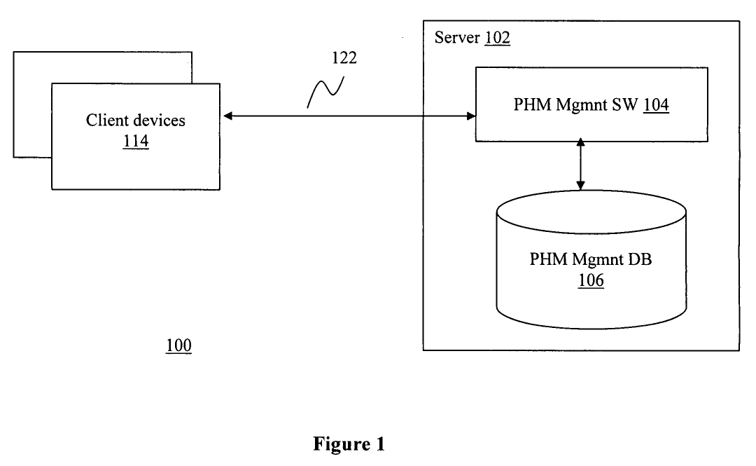

Referring now to FIG. 1, wherein an overview of the present invention, in accordance with various embodiments, is shown. As illustrated, for the embodiments, server 102 is endowed with PHM Management Software 104, which is adapted with functions to facilitate entities in managing PHM usage. In particular, as will be described in more detail below, PHM Management Software 104 is adapted with functions to facilitate an entity in implementing a process to regulate PHM usage by its personnel at various sites/locations of the entity, including in particular, request and approval of PMH usage. In various embodiments, Software 104 enables (an administrator of) the entity to establish the process by defining (selecting) a number of management tasks. Typically, the management tasks are to be completed, before usage of a PHM may be approved, and start. Software 104 further enables personnel of the entity to enter PHM usage requests online, and assists the personnel in tracking performance of the required management tasks to completion, including in particular, the tasks required for usage approval. In alternate embodiments, some or all of the defined/selected management tasks may be made optional, before requested usage of a PHM may be approved and start.

As illustrated, for the embodiments, server 102 is also provided with PHM database 106 for storing data associated with regulating PHM usage at the various sites/locations of the entity. In alternate embodiments, PHM database 106 may be remotely disposed away from server 102 instead.

In various embodiments, PHM Management Software 104 facilitates definition (selection) of the management tasks, entry of PHM usage requests and their tracking, including approval, via client devices 114 (of the entity). For the embodiments, client devices 114 are coupled to servers 102 via network connections 122 over a number of private and/or public networks, including but are not limited to the Internet. In alternate embodiments, PHM Management Software 104 may facilitate definition (selection) of the management tasks, entry of PHM usage requests and their tracking, including approval, via offline input and/or feedback instead.

Except for PHM Management Software 104 and PHM Database 106, server 102 and client devices 114 otherwise represent a broad range of these elements known in the art, or to be designed (as long as they are consistent with the teachings of the present invention). Accordingly, except for PHM Management Software 104 and PHM Database 106, and an example of server 102, client devices 114 and coupling 122 will not be further described.

While for ease of understanding, server 102 is “singularly” illustrated, in various embodiments, server 102 may be a single computing device, a cluster of tightly coupled computing devices, or networked computing devices.

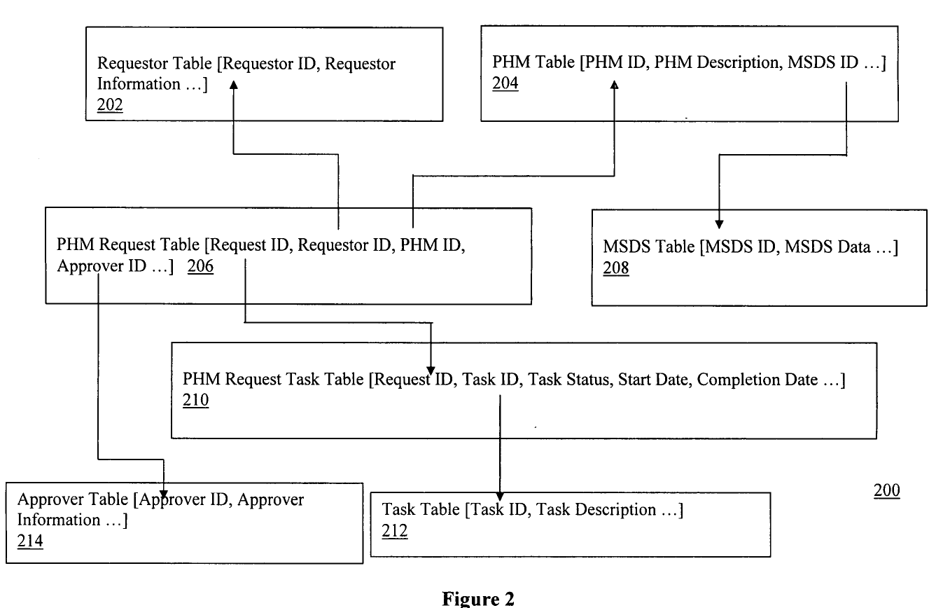

FIG. 2 illustrates a data organization suitable for use to organize data of PMH DB 106, in accordance with various embodiments. As illustrated, for the embodiments, data organization 200 includes Requestor Table 202, PHM Table 204, PHM Request Table 206, MSDS Table 208, PHM Request Task Table 210, Task Table 212, and Approver Table 214, logically coupled to each other as shown.

Requestor Table 202 has a number of rows for storing data associated with PHM usage requesters of the entity, one row per requestor. For the embodiments, each row includes a first column for storing an identification for a requestor, and one or more additional columns for storing descriptions of the requestor, which may include, but are not limited to, e.g., name, title, department, phone extension, email address and so forth, of the requester.

Similarly, PHM Table 204 has a number of rows for storing PHM data, one row per PHM. For the embodiments, each row includes a first column for storing an identifier of a PHM, and one or more columns for storing descriptions of the PHM, which may include, but are not limited to, e.g., an identifier type for the PHM identifier, a common name of the PHM, a manufacturer of the PHM, synonyms of the PHM, a MSDS identifier, and so forth. In various embodiments, the identifier type of a PHM identifier may be a UPC type (UPC=Uniform Product Code) or a SKU type (SKU=Stock Keeping Unit).

Likewise, PHM Request Table 206, has a number of rows for storing PHM usage request data, one row per PHM usage request. For the embodiments, each row includes a first column for storing an identification of a request for usage of a PHM, a second column for storing an identification of a requestor, a third column for storing an identifier of the PHM, which usage is requested, and a fourth column for storing an identifier of an approver. An approver of a request may be dependent on e.g., the PHM requested, the requester, and so forth.

MSDS Table 208, on the other hand, has a number of rows for storing MSDS data, one row per MSDS. For the embodiments, each row includes a first column for storing an identification of a MSDS, and a second column for storing a file identifier of a file having associated data of the MSDS, which may include, but are not limited to, e.g., the special handling procedure, the storage procedure, the fire fighting procedure, the date it was first downloaded, the data it was last updated, and so forth.

PHM Request Task Table 210 has a number of rows for storing data associated with each of the required (or optional) management tasks associated with the approval of each PHM usage request, one row per task of a request. For the embodiments, each row includes a first and a second column for storing an identification of a request and an identification of a task, and one or more additional columns for storing associated data of the task of the request, which may include, but are not limited to, e.g., the request task's status (e.g., not yet started, in process, completed), a start date and a completion date of the request task, and so forth.

Task Table 212 has a number of rows for storing data associated with each of the required (or optional) management tasks, one row per required task. For the embodiments, each row includes a first column for storing an identification of a task, and one or more additional columns for storing associated data of the required/optional task, which may include, but are not limited to, e.g., the required/optional task's description, resource of the required/optional task, and so forth.

Approver Table 214 has a number of rows for storing data associated with PHM usage approvers of the entity, one row per approver. For the embodiments, each row includes a first column for storing an identification for an approver (which may be a material specialist, a manager, and so forth), and one or more additional columns for storing descriptions of the approver, which may include, but are not limited to, e.g., name, title, department, phone extension, email address and so forth, of the approver.

Accordingly, requester, PHM, MSDS, task status, task information, and approver may be readily “looked up” from Requestor, PHM, MSDS, Requestor Task, Task, and Approver Tables 202, 204, 206, 210, 212 and 214, respectively, reducing the amount of storage required to practice various embodiments of the invention. In alternate embodiments, PHM DB 106 may be practiced with other data organizations instead.

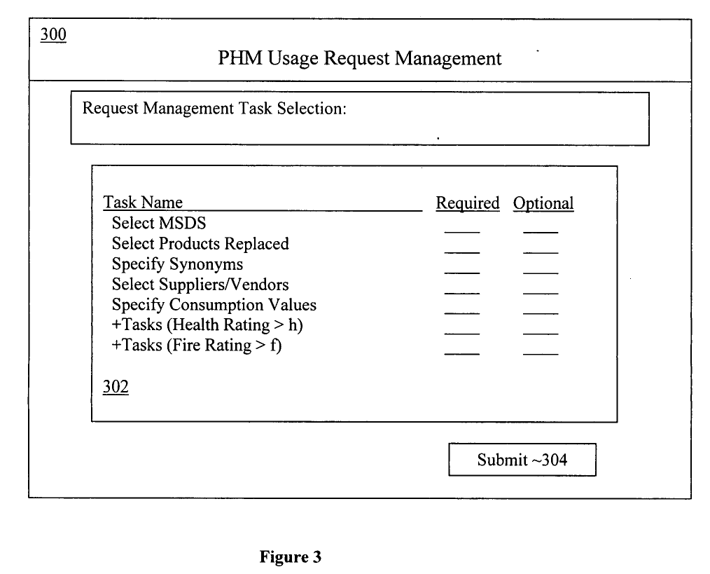

FIG. 3 illustrates one aspect of the user interface provided by PHM Management Software 104 of FIG. 1, in accordance with various embodiments. More specifically, it illustrates a selection window 300 provided by Software 104 for (an administrator of) an entity to define (select) the management tasks, which performance may be required prior to the start of usage of a PHM. Selection window 300 may be presented to the administrator of the entity during installation or post-installation of Software 104.

For the embodiments, selection window 300 includes a list 302 of a number of pre-selected management tasks, from which the administrator of the entity may designate as either required or optional. For the embodiments, the pre-selected management tasks include Selection of MSDS, Selection of Products Replaced, Specification of Synonyms, Selection of Suppliers/Vendors and Specification of Consumption Values, and so forth, for the PHM which usage is being requested. For the embodiments, the pre-selected management tasks may further include additional tasks (+Tasks) to be performed for PHM which health rating is greater than a predetermined threshold (h), and/or additional tasks (+Tasks) to be performed for PHM which flammability rating is greater than a predetermined threshold (f). May also include any number of user-defined tasks and associated user-defined data.

Additionally, for the embodiments, window 300 further includes “submit” button 302 for an administrator to submit his/her selection of required/optional management tasks for the PHM usage regulation process of his/her entity.

In various embodiments, the management tasks may be pre-selected by the vendor/implementor of Software 104. All or a high priority subset of the pre-selected management tasks may also be required by default, unless an administrator configure to the contrary for an entity. In other embodiments, the pre-selected management tasks, including whether they are required by default, may vary depending on the industry of an entity or other criteria. The pre-selected management tasks may also include other tasks in addition to or in lieu of the example management tasks described above.

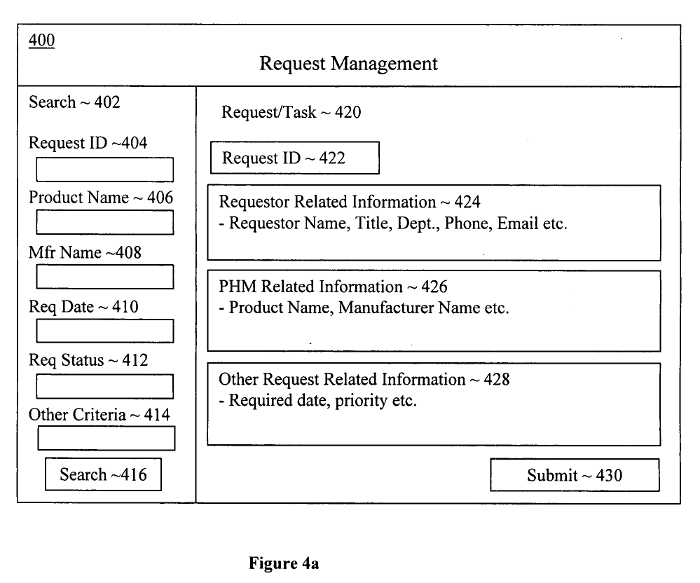

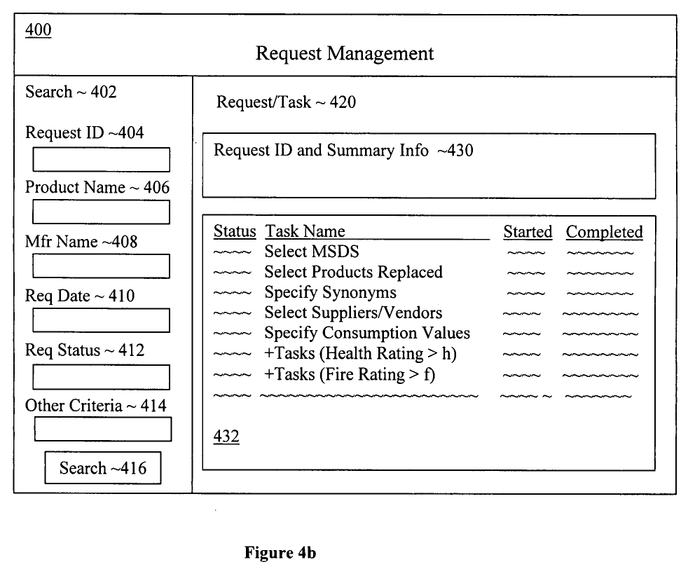

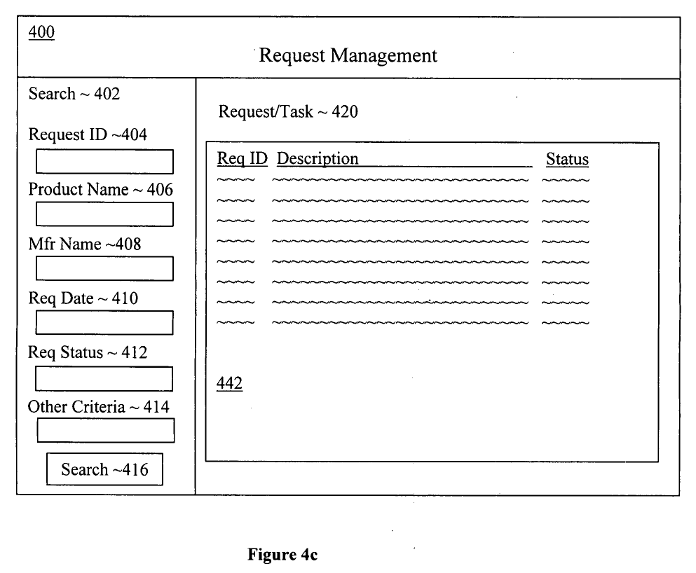

FIGS. 4a-4c illustrate additional aspects of the user interface provided by PHM Management Software 104 of FIG. 1, in accordance with various embodiments. More specifically, the figures illustrate window 400 having at least three instantiations. These instantiations include an instantiation (FIG. 4a) through which a new PHM usage request may be entered online by a personnel of an entity. Additionally, the instantiations include an instantiation (FIG. 4b) through which the statuses of the required tasks of a request may be reviewed, and an instantiation (FIG. 4c) through which all requests matching a particular search (having particular search criteria, e.g., a requestor) may be reviewed.

For the embodiments, window 400 includes an invariant section 402 that remains unchanged from instantiation to instantiation irrespective of the current use, and a variant section 420 that changes from instantiation to instantiation depending on the current use. Invariant section 402 includes a number of fields 404-414 to facilitate entry of one or more search criteria to locate a request, a number of requests or a number of tasks of interest to a user. Variant section 420 on the other hand, presents different information depending on whether window 400 is presented to facilitate entry of a new request for usage of a PHM online, review of tasks associated with a request, or review of requests matching certain search criteria.

For the embodiments, field 404 facilitates entry of an identifier of a request as a search criterion. Field 406 facilitates entry of a product name of a PHM as a search criterion. Field 408 facilitates entry of a manufacturer name of a PHM as a search criterion. Field 410 facilitates entry of a request date as a search criterion. Field 412 facilitates entry of a request status as a search criterion. Field 414 represents an additional field that may be implemented in other embodiments to facilitate entry of other data as a search criterion. For the embodiments, fields 404-414 may be used individually or in combination.

Additionally, for the embodiments, invariant section 402 further includes a “search” button 416 for a user to submit a search, after entering one or more search criteria.

Referring now specifically to FIG. 4a, for the embodiments, when used to facilitate entry of a new PHM usage request online, variant section 420 includes areas 422-428. Area 422 facilitates display of an identifier for the PHM usage request. Area 424 facilitates entry and display of information related to the requester of the request. As described earlier, examples of requester related information include, but are not limited to, a name, a title, a department, a phone extension, and an email address of the requester. Area 426 facilitates entry and display of information related to the PHM which usage is requested. As described earlier, examples of PHM related information include, but are not limited to, a product name and a manufacturer name of the PHM which usage is requested. Area 428 facilitates entry and display of other information related to the request. As described earlier, examples of other PHM usage request related information include, but are not limited to, a required date and a priority of the PHM usage request.

Additionally, for the embodiments, when used to facilitate entry of a new PHM usage request online, variant section 420 includes further includes a “submit” button 430 for a user to submit a new PHM usage request, after completing all the required fields.

As illustrated in FIG. 4b, for the embodiments, when used to facilitate review of the statuses of the various required tasks of a PHM usage request, variant section 420 includes areas 430-432. The PHM usage request, which task statuses are being reviewed, may be a PHM usage request matching one or more search criteria entered in the invariant section 402. Area 430 facilitates display of a request identifier and summary information associated with a request, which task statuses are being reviewed. The summary information may be any combination and/or abstraction of the example information described earlier. Area 432 facilitates display of the task statuses of the PHM usage request. As described earlier, the tasks may include, but are not limited to, the tasks of Selecting MSDS, Specifying Synonyms, Selecting Suppliers/Vendors, and so forth. The task status information, in addition to whether the task has started, in progress or completed, may also include the start and completion dates of the various tasks.

As illustrated in FIG. 4c, for the embodiments, when used to facilitate review of selected requests/tasks (matching the entered search criteria), variant section 420 includes area 442, which facilitates display of brief descriptions of the matching requests/tasks. The brief descriptions may include e.g., the request identifications, the task names, their statuses, and so forth. In various embodiments, each displayed request/task may be selected, and the selection results in the display of a more description of the selected request/task.

In various embodiments, Software 104 may provide more or less functions and/or user interfaces.

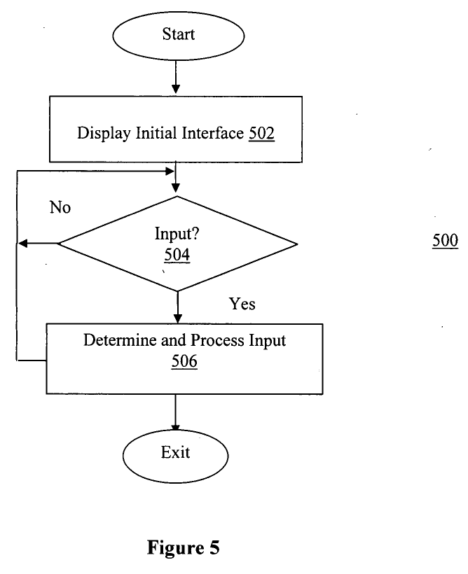

FIG. 5 illustrates a flow chart view of selected operations of PHM Management Software 104 of FIG. 1, in accordance with various embodiments. As illustrated, for the embodiments, on start up, Software 104 causes an user interface, e.g. user interface 300 or 400 to be rendered on a display, block 502. User interface 300 is rendered when Software 104 is started (e.g. by an authorized administrator of an entity), to configure an entity's management process. Whereas, user interface 400 is rendered, when Software 104 is started by a general user of an entity.

Thereafter, Software 104 waits for an input, e.g., selection of one of the suggested management tasks (during configuration of the management process of an entity) or entry of a search criterion (during general use), block 504.

On receipt, Software 104 determines the input, and processes the input accordingly, block 506. For examples,
during configuration of the management process of an entity, in response to the selection of a suggested management tasks, Software 104 updates the appropriate row of Request Task Table 210 of PHM DB 106 accordingly;
during general use, in response to the selection of the submit button (FIG. 4a), Software 104
   determines if all the required fields have been filled correctly,
   if not, requests for their correction, and
   if they are, creates the appropriate record in PHM Request Task Table 210 of PHM DB 106 for the newly entered PHM usage request accordingly;
during general use, in response to the selection of the search button, with an request identifier entered as search criterion (FIG. 4b), Software 104
   selects and retrieves the appropriate record from PHM Request Task Table 210 (appropriately joined with other Tables 202-208 and 212 if necessary) of PHM DB 106, matching the specified request identifier, and
   returns the retrieved record to client device 114; and
during general use, in response to the selection of the search button, with one or more search criteria (other than request identifier) entered (FIG. 4c), Software 104
   selects and retrieves records from PHM Request Task Table 210 (appropriately joined with other Tables 202-208 and 212 if necessary) of PHM DB 106, matching the specified search criteria, and
   returns the retrieved records to client device 114.

In other embodiments, other processing, in addition to, or in lieu of some of the earlier described processing may be supported.

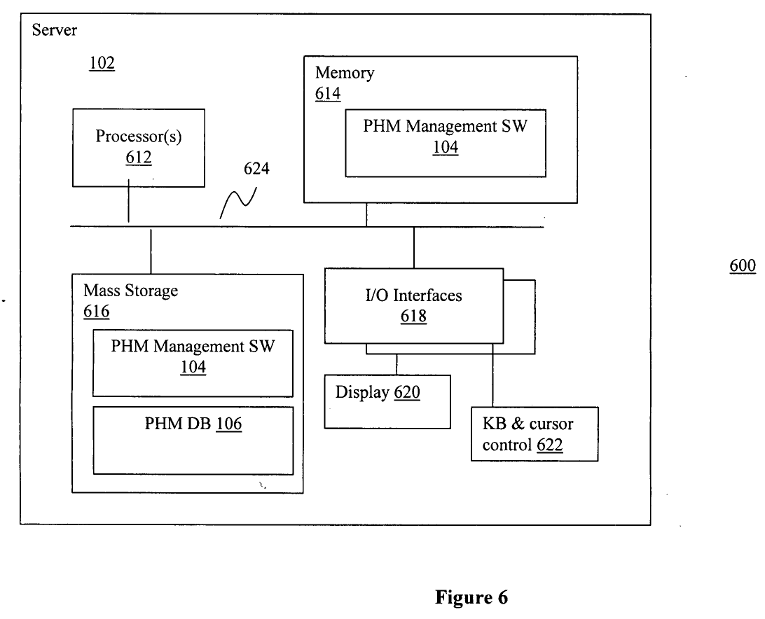

FIG. 6 illustrates an example implementation of server 102 of FIG. 1, in accordance with various embodiments. As illustrated, server 102 includes digital computing processor 612, memory 614 coupled to each other via bus 624. Further, device 612 includes mass storage device 616, I/O interfaces 618, and a number of I/O devices coupled to each other and the earlier described elements as shown. Memory 614 and mass storage device 616 include in particular, a transient and a persistent copy of PHM Management Software 104 respectively. Mass storage device 616 further includes PHM database 106. The I/O devices include in particular, display 620 and keyboard/cursor control 622.

In various embodiments, processor 612 may be any one of a number of microprocessors known in the art, or to be designed (as long as they are consistent with the teachings of the present invention), including but are not limited to, the processors available from Intel Corp., of Santa Clara, Calif.

Memory 614 may likewise be any one of a number of volatile storage known in the art or to be designed (as long as they are consistent with the teachings of the present invention), including but are not limited to, the volatile storage available from Kingston Technology of Fountain Valley, Calif. Mass storage device 616 may likewise be any one of a number of non-volatile storage known in the art or to be designed (as long as they are consistent with the teachings of the present invention), including but are not limited to, the non-volatile disk storage available from Seagate of City, Calif.

In various embodiments, I/O interfaces 618 include a communication interface for coupling server 102 to client devices 114. The communication interface may be a wire based or wireless interface, coupling server 102 to devices 114 via a wired/wireless local/wide area network. An example of a suitable wired network interface includes but is not limited to an Ethernet interface, and an example of a suitable wireless network interface includes but is not limited to an IEEE 802.11b network interface.

Except for PHM Management Software 104 (earlier described), and the manner these elements are employed, each of these elements represents a broad range of the corresponding element known in the art or to be designed, consistent with the teachings of the present invention. The elements perform their conventional functions, i.e. processing, storage, reading, displaying, and so forth.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. An apparatus comprising:
storage medium having stored therein a plurality of instructions adapted to facilitate a user in submitting online a request for a potentially hazardous material, and facilitate tracking of the request, including tracking of statuses of one or more tasks, which completions are required before the request can be satisfied; and
at least one processor coupled to the storage medium to execute the instructions.

2. The apparatus of claim 1, wherein the instructions are adapted to facilitate the user to enter online for the request, a product name to identify the requested potentially hazardous material.

3. The apparatus of claim 2, wherein the instructions are further adapted to facilitate the user to enter online for the request, a name of a manufacturer for the requested potentially hazardous material.

4. The apparatus of claim 2, wherein the instructions are further adapted to facilitate specification of a synonym for the product name.

5. The apparatus of claim 1, wherein the instructions are adapted to facilitate selection of a material safety data sheet for the requested potentially hazardous material.

6. The apparatus of claim 1, wherein the instructions are further adapted to facilitate specification of at least one of a consumption location, a storage location, and a consumption level for the requested potentially hazardous material.

7. The apparatus of claim 1, wherein the instructions are further adapted to facilitate specification of at least one of a health rating and a flammability rating for the requested potentially hazardous material.

8. The apparatus of claim 1, wherein the instructions are further adapted to assign a request identifier to identify the request.

9. The apparatus of claim 1, wherein the instructions are further adapted to report on the completion statuses of the required tasks of the request.

10. The apparatus of claim 1, wherein the instructions are further adapted to facilitate the user to enter online multiple requests for multiple potentially hazardous materials, track the completion statuses of the required tasks of the multiple requests, and report on requests associated with the user.

11. The apparatus of claim 1, wherein the instructions are further adapted to facilitate another user in selecting one or more tasks to configure a potentially hazardous material usage regulation process to regulate request for potentially hazardous material.

12. The apparatus of claim 11, wherein the instructions are further adapted to suggest a plurality of tasks for selection by the other user.

13. A method of operation on a computer system, comprising:
facilitating a user in submitting online a request for a potentially hazardous material; and
facilitating electronic tracking of the request, including tracking of statuses of a plurality of tasks, which completions are required prior to the approval of the request.

14. The method of claim 13, wherein the facilitating of the user in submitting online a request for potentially hazardous material includes facilitating the user in entering online for the request, a product name to identify the requested potentially hazardous material.

15. The method of claim 14, wherein the facilitating of the user in submitting online a request for potentially hazardous material further includes facilitating the user in entering online for the request, a name of a manufacturer for the requested potentially hazardous material.

16. The method of claim 14, further comprising facilitating online specification of a synonym for the product name.

17. The method of claim 13, further comprising facilitating online selection of a material safety data sheet for the requested potentially hazardous material.

18. The method of claim 13, further comprising facilitating online specification of at least one of a consumption location, a storage location, and a consumption level for the requested potentially hazardous material.

19. The method of claim 13, further comprising facilitating online specification of at least one of a health rating and a flammability rating for the requested potentially hazardous material.

20. The method of claim 13, further comprising online assigning a request identifier to identify the request.

21. The method of claim 13, further comprising online reporting on the completion statuses of the required tasks of the request.

22. The method of claim 13, further comprising repeating said facilitating for multiple online requests for multiple potentially hazardous materials, and reporting on requests associated with the user.

23. The method of claim 13, wherein further comprising facilitating another user in online selecting one or more tasks to configure a potentially hazardous material usage regulation process to regulate request for potentially hazardous material.

24. The method of claim 23, further comprising online suggesting a plurality of tasks for selection by the other user.

25. An apparatus comprising:
storage medium having stored therein a plurality of instructions adapted to suggest a plurality of tasks for selection by a user to configure a potentially hazardous material usage regulation process to regulate request for potentially hazardous material, and
facilitate the user in selecting one or more of the suggested tasks; and
at least one processor coupled to the storage medium to execute the instructions.

26. The apparatus of claim 25, wherein the tasks comprise one or more selected from the group consisting of a task to select a material safety data sheet, a task to specify a product name for a requested potentially hazardous material, a task to specify a manufacturer name for a requested potentially hazardous material, and a task to specify a consumption value for a requested potentially hazardous material.

27. A method of operation on a computing device, comprising:
presenting on the computing device, a plurality of tasks for selection by a user to configure a potentially hazardous material usage regulation process to regulate request for potentially hazardous material; and
facilitate the user in selecting one or more of the suggested tasks, using the computing device.

28. The method of claim 27, wherein the tasks comprise one or more selected from the group consisting of a task to select a material safety data sheet, a task to specify a product name for a requested potentially hazardous material, a task to specify a manufacturer name for a requested potentially hazardous material, and a task to specify a consumption value for a requested potentially hazardous material.

29. A computer readable medium comprising:
storage medium; and
a plurality of instructions designed to program an apparatus to enable the apparatus to practice the method of claim 13 or 27.
